(19) United States
(12) Patent Application Publication
(10) Pub. No.: US 2025/0036924 A1
(43) Pub. Date: Jan. 30, 2025

(54) A self-learning method of generative adversarial multi-headed attention neural network for aero-engine data reconstruction

(71) Applicant: DALIAN UNIVERSITY OF TECHNOLOGY, Dalian (CN)

(72) Inventors: Song MA, Dalian (CN); Tao SUN, Dalian (CN); Zengsong XU, Dalian (CN); Ximing SUN, Dalian (CN); Zhi LI, Dalian (CN)

(21) Appl. No.: 18/548,204

(22) PCT Filed: Oct. 28, 2022
(86) PCT No.: PCT/CN2022/128101

§ 371 Date: Aug. 28, 2023

(30) Foreign Application Priority Data
Oct. 24, 2022 (CN) 202211299935.5

(51) Int. Cl. G06N 3/0475; G06N 3/094

(52) U.S. Cl. CPC G06N 3/0475; G06N 3/094

(57) ABSTRACT

A generative adversarial multi-headed attention neural network self-learning method for aero-engine data reconstruction belongs to the field of end-to-end self-learning of aero-engine missing data. First, the samples are pre-processed, and the machine learning algorithm is used to pre-fill the normalized data first, and the pre-filled information is involved in the network training as part of the training information. Second, a generative adversarial multi-headed attention network model is constructed and the trained sample set is used to train the generative adversarial multi-headed attention network model. Finally, the samples are generated using the trained sample generator G. The method uses the generative adversarial network to better learn the distribution information of the data, and uses parallel convolution and multi-headed attention mechanism to fully exploit the spatial and temporal information among the aero-engine data.

### TECHNICAL FIELD

our invention belongs to a field of end-to-end self-learning of missing aero-engine data and relates to a method of generative adversarial network modelling based on a convolutional multi-headed attention mechanism for aero-engine data imputation;

### BACKGROUND TECHNIQUES

as a “heart” of an aircraft, the health of an aircraft engine affects the safety of its flight; the aircraft engine works in a high temperature, high pressure and high noise environment all year round, so the measurement of aircraft engine related parameters is a difficult and challenging task; in fact, common problems in the measurement process are mainly due to abnormal vibrations, electromagnetic interference, sensor measurement errors and faults, which can lead to interruptions in data collection and cause problems such as missing data from some sensors; in practice, if a database collects incomplete data, it will not only cause discrepancies between actual data and prior estimates, but also reduce the accuracy of calculations, which results in data processing errors and limits subsequent predictions and maintenance;

currently, there are several approaches to handle missing data problem for the aero-engine:

1) traditional statistics-based approach

a data imputation problem can be firstly categorized in the field of statistics, and its core idea is to use some statistical knowledge to achieve effective imputation of missing data, including mean imputation, plural imputation, and great likelihood estimation; among them, the mean-imputation and plurality-imputation methods lack randomness and lose a lot of effective information of data, while the great likelihood estimation method is more complicated to calculate; their common drawback is that they cannot effectively explore the correlation among the attributes of multivariate data;

2) KNN method based on machine learning

machine learning methods for the data imputation problem, such as the common KNN imputation method, are obviously affected by the size of the data, and the distance between the data needs to be calculated when finding the nearest neighbors, so the larger the data size is, the more computation time is required, but when the data size is small, there is no guarantee that the K nearest neighbors selected are sufficiently close to the data to be imputed;

in the light of the above discussion, the present invention is designed to generate adversarial network self-learning technique based on convolutional self-attention mechanism, which is a modeling method for missing data of aero-engine with coupled multivariate time series characteristics; this patent is funded by the China Postdoctoral Science Foundation (2022TQ0179) and the National Key Research and Development Program (2022YFF0610900);

### INVENTION CONTENT

the present invention addresses the limitations of current aero-engine missing data reconstruction algorithms and provides a generative adversarial network modeling method based on convolutional multi-headed attention mechanism with better accuracy; since an aero-engine is a highly complex aerodynamic-thermal-mechanical system, the time series data it generates are highly correlated, so it has been a challenging challenge to make full use of the attribute correlation and temporal correlation in the aero-engine data to predict the missing data of the aero-engine;

to achieve the above purpose, the technical solution used in the present invention is:

a convolutional multi-headed attention mechanism based generative adversarial network modeling method for aero-engine missing data, comprising the following steps:

step S1: sample pre-processing

1) a aero-engine data set with missing values is divided into a training sample set and a test sample set, the training sample set is used for the training of the model, and the test sample set is used for the testing of the model after training, and since the training sample set and the test sample set are processed in the same way, no distinction is made in the following formulation, assuming that the aero-engine data has n attributes, which are uniformly denoted by X={X₁, X₂, . . . Xₙ};

2) marking missing values

since X contains missing values, the missing items are represented by NAN and the non-missing items are the original values, a mask matrix M of equal size to X is constructed, and for the missing items in X, the corresponding position of the mask matrix is marked as 0, and for the non-missing items in X, the corresponding position of the mask matrix is marked as 1, so as to achieve the marking of missing data and non-missing data;

3) due to the excessive differences in values between some sensors of the aero-engine, the scales of these features are different if the raw data are used directly, which will have an impact on the subsequent training of the neural network; therefore, by normalization, it is possible to make different features have the same scale; in this way, when using gradient descent to learn the parameters, the degree of influence of different features on the parameters is the same; for the unmissing term, all sensor data are standardized uniformly using the following formula:

$${X}_{i}^{′} = \frac{{X}_{i} - {mean}_{i}}{{σ}_{i}} i ∈ ( 1 , 2 , … n ) \qquad ( 1 )$$

where X′ᵢ denotes the normalized data of feature i, Xᵢ denotes the original data of feature i, meanᵢ denotes the mean of feature i, σᵢ denotes the variance of feature i; for the missing term, NAN is replaced by 0, and finally the normalized multivariate time-series data X′={X′₁, X′₂, . . . X′ₙ} is obtained;

4) constructing temporal samples using the sliding window method

for X′, M, the sliding window method is used to slide in the time dimension to extract the temporal information of the samples and construct a series of temporal samples of size n×Windowsize, where n is the feature dimension of the samples, Windowsize is the window size, i.e., X′ and M are reconstructed into the form of m×n×Windowsize, and m is the number of samples, depending on the original sample size;

step S2, pre-imputation

since the data generated by the generative adversarial network has a large randomness, in order to make the data generated by the network fit the original data distribution better, the machine learning algorithm is used to pre-imputation first, and the pre-imputed information is used as part of the training information to participate in the network training;

step S3: build a generative adversarial multi-headed attention network model

1) the generative adversarial network modeling method based on convolutional multi-headed attention mechanism for aero-engine missing data mainly consists of a generator and a discriminator; the generator consists of a parallel convolutional layer, a fully connected layer, a position encoding layer, an N-layer TransformerEncoder module, a parallel convolutional layer and a fully connected layer, i.e., expressed by the following equation:

$$Conv 1 {d}_{1 \times 1} \& Conv 1 {d}_{1 \times 3} - Linear - PositionalEncoding - N \times TransformerEncoder - Conv 1 {d}_{1 \times 1} \& Conv 1 {d}_{1 \times 3} - Linear \qquad ( 2 )$$

the mentioned parallel convolutional layer and fully connected layer (Conv1d_{1×1}&Conv1d_{1×3}−Linear) are designed to efficiently extract the attribute correlations of aero-engine multivariate data, and the parallel convolutional layer consists of and in parallel, which are then combined by the fully connected layer as subsequent inputs;

the position encoding layer (PositionalEncoding) is described to enable the model to inject some information about the relative or absolute position of the markers in the sequence, using the sequence's order; to this end, the invention adds PositionalEncoding to the input, using equation (3) for position encoding, where n is the window size, pos is the temporal position, d_{model} is the total number of dimensions of the data, and d is the number of dimensions,

$$d ∈ ( 0 , 1 … {d}_{model} - 1 ) , i = ⌊ \frac{d}{2} ⌋ ;$$

that is, each dimension of the position encoding corresponds to a different sine cosine curve, whereby the position of the input data can be individually and uniquely marked and finally used as input for the subsequent N-layer TransformerEncoder layer;

$${PE}_{( pos , 2 i )} = sin ( pos / {10000}^{2 i / {d}_{model}} ) \\ {PE}_{( pos , 2 i )} = cos ( pos / {10000}^{2 i / {d}_{model}} ) \\ pos ∈ ( 1 , 2 … n ) , i ∈ ( 0 , 1 … \frac{{d}_{model}}{2} - 1 ) \qquad ( 3 )$$

the said N-layer TransformerEncoder layer is a module consisting of N TransformerEncoder connected in series, and TransformerEncoder consists of a multi-headed attention module layer, a residual connection layer, and a feed-forward network layer residual connection laver, i.e., expressed by the following equation:

$$\begin{matrix}Attention ( Q , K , V ) = softmax ( \frac{{QK}^{T}}{\sqrt{{d}_{k}}} ) V & ( 6 ) \\ MultiHead ( Q , K , V ) = Concat ( {head}_{1} , … , {head}_{h} ) {W}^{O} \\ {head}_{i} = Attention ( {QW}_{i}^{Q} , {KW}_{i}^{K} , {VW}_{i}^{V} ) i ∈ ( 1 , 2 … h ) & ( 6 )\end{matrix}$$

where MultiHead Attention is spliced from multiple Attentionmodules in parallel, Attention modules as in Equation (5), MultiHead Attention modules as in Equation (6):

$$MultiHead Attention - Add \& Norm - Feed Forward - Add \& Norm \qquad ( 4 )$$

where h denotes the number of heads of multi-headed attention, and Wᵢ^{Q}∈ [symbol] ^{d}^{_{model}}^{×d}^{ₖ}, Wᵢ^{K}∈ [symbol] ^{d}^{_{model}}^{×d}^{ₖ}, Wᵢ^{V}∈ [symbol] ^{d}^{_{model}}^{×d}^{ᵥ}, W^{O}∈ [symbol] ^{hd}^{ᵥ}^{×d}^{_{model}} denote the corresponding unknown weights, respectively; it can be described as mapping the query (Q) and the key-value pair (K-V) to the output, where Q, K, V and the output are vectors and the output values are weighted by the computed values, and; when Q, K, and V inputs are the same, it is called self-attentive;

2) a random matrix Z of equal size to X is constructed and imputed with random numbers with mean 0 and variance 0.1 for the missing items and 0 for the non-missing items, thus introducing certain random values to make the model training more robust afterwards;

3) based on the mask matrix M, a matrix M′ is constructed that is identical to M; then, for all the terms in the matrix M′ that are 0, they are set to 1 with 90% probability, and finally the hint matrix H is obtained;

the input data of generator G are normalized multivariate temporal data X′, random matrix Z, mask matrix M, and pre-imputation matrix Xₚᵣₑ; the inter-attribute association information is extracted using parallel convolutional layers, the temporal information of the input data is encoded using positional encoding, the temporal information is extracted efficiently using N-layer TransformerEncoder module, and finally the complete data information X_{g} is output using parallel convolutional and fully connected layers, and the missing items in X′ are imputed using X_{g} term is imputed; the discriminator D and the generator G are almost identical in structure, only Sigmoid activation function is added in the last layer to calculate the cross entropy loss, the input of discriminator is the imputed data matrix Xᵢₘₚᵤₜₑ, and the hint matrix H and pre-imputation matrix Xₚᵣₑ generated from the mask matrix, the output result is the prediction matrix X_{d}, the element value in the prediction matrix indicates the probability that the corresponding element in Xᵢₘₚᵤₜₑ is the real data;

step S4, generating the adversarial multi-headed attention network model using the training sample set training;

$$\begin{matrix}{D}_{loss} = - {𝔼}_{M , {X}_{d}} ( {M}^{T} log {X}_{d} + {( 1 - M )}^{T} log ( 1 - {X}_{d} ) ) & ( 7 ) \\ {G}_{loss} = - {𝔼}_{M , {X}_{d}} ( {( 1 - M )}^{T} log ( {X}_{d} ) ) + λ {‖ {X}^{′} * M - {X}_{g} - M ‖}_{2} + β {‖ {X}_{pre} * ( 1 - M ) - {X}_{g} * ( 1 - M ) ‖}_{2} & ( 8 )\end{matrix}$$

1) training of the network includes two parts: training of the discriminator D and training of the generator G, where equation (7) is the cross-entropy loss function of discriminator D and equation (8) is the loss function of generator G, where [symbol] denotes expectation, M is the mask matrix, Xₚᵣₑ is the pre-imputation data, X_{g} is the data generated by generator G, X_{d} is the probability matrix of discriminator D output, and λ, β are hyperparameters; the following equation (9) for the imputed data set:

$${X}_{impute} = {X}^{′} * M + {X}_{g} * ( 1 - M ) \qquad ( 9 )$$

4) the generator G and the discriminator D are trained alternately, and the generator generates sample X_{g}, trying to fit the real data, i.e., the distribution of the data without missing items, and the discriminator D discriminates the probability that the sample generated by the generator G is true, playing each other and promoting each other;

5) step S5: generate sample using the trained sample generator G;

6) after the training, the sample set with test samples is preprocessed as shown in step 1 and input to the trained generator G to obtain the generated samples X_{g}.

7) step S6: reconstruct the missing values by using the generated samples

8) using equation (9), we finally get the complete imputed samples Xᵢₘₚᵤₜₑ and complete the reconstruction of missing data for the whole dataset; after the completion of the missing data reconstruction, it can be used as the data set for the subsequent fault diagnosis and health maintenance work to achieve the maximum utilization of the aero-engine sensor data containing the missing data;

9) beneficial effects of the present invention:

10) the present invention uses generative adversarial network to better learn the distribution information of the data, and uses parallel convolution and multi-headed attention mechanism to fully exploit the spatial and temporal information among the aero-engine data, which can effectively improve the self-learning accuracy of the missing data compared with the existing imputation algorithm, and is of great significance to the subsequent prediction and maintenance of aero-engines;

### DESCRIPTION OF THE ATTACHED DRAWINGS

FIG. 1 is a flow chart of the technology of the present invention;

FIGS. 2a to 2c are diagrams of the proposed generative adversarial network imputation self-learning model of the present invention, wherein FIG. 2a is the improved generative adversarial data imputation self-learning architecture proposed by the present invention, FIG. 2b is the generator model proposed by the present invention, and FIG. 2c is the discriminator model proposed by the present invention;

FIGS. 3a to 3c show a sub-model of the model of FIGS. 2a to 2c, wherein FIG. 3a is a click-scaling attention model, FIG. 3b is a multi-headed attention model, and FIG. 3c is a parallel convolution and linear layer model;

FIG. 4 is a comparison of the root mean square difference (RMSE) effect at missing rates {0.1, 0.3, 0.5, 0.7, 0.9} under the C-MAPSS dataset commonly used for aero-engine health management, where this is the result of the algorithm of the present invention, knn is the result of the K-nearest neighbor imputation algorithm, and mean is the result of the mean imputation algorithm;

### SPECIFIC IMPLEMENTATION

this implementation of the generative adversarial multi-headed attention neural network self-learning technique for aero-engine data reconstruction is validated using the FD001 dataset from the C-MAPSS experimental data, which is a dataset without missing values, and the given engines in the dataset all belong to the same model, and there are 21 sensors in each engine, and the dataset combines these several The sensor data of these several engines are jointly constructed in the form of a matrix, where each engine sensor data has a different time series length, but all represent the complete life cycle of the engine; the FD001 dataset contains 200 engine degradation data, and since in the present invention is the reconstruction of missing data of aero-engines without remaining life prediction, the original dataset divided between test_FD001 and train_FD001 are combined, and then randomly disrupted by engine number as the smallest unit, 80% of the data with engine numbers are selected as the training set and 20% of the data with engine numbers are used as the test set, and the test set is manually randomly missing at the specified missing rate;

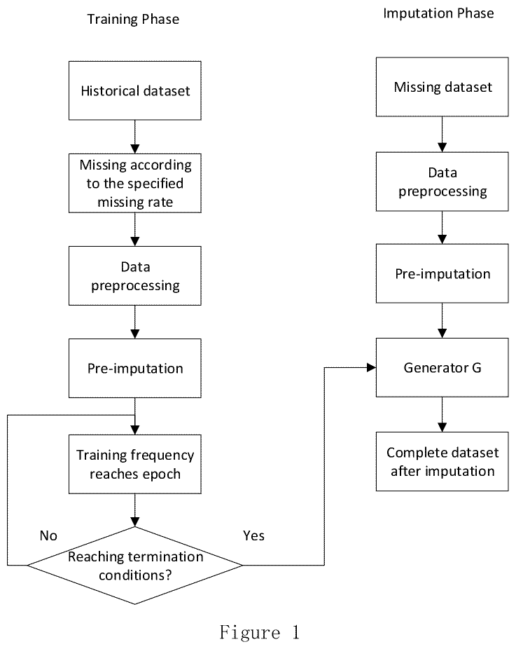

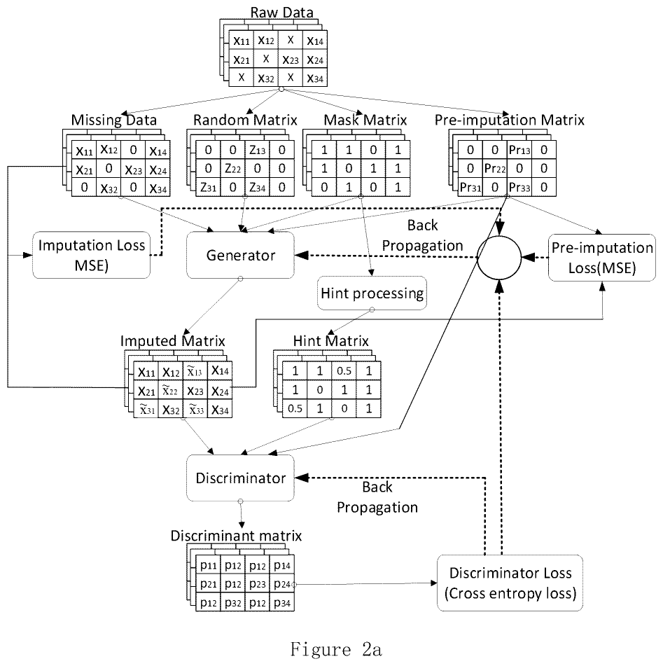

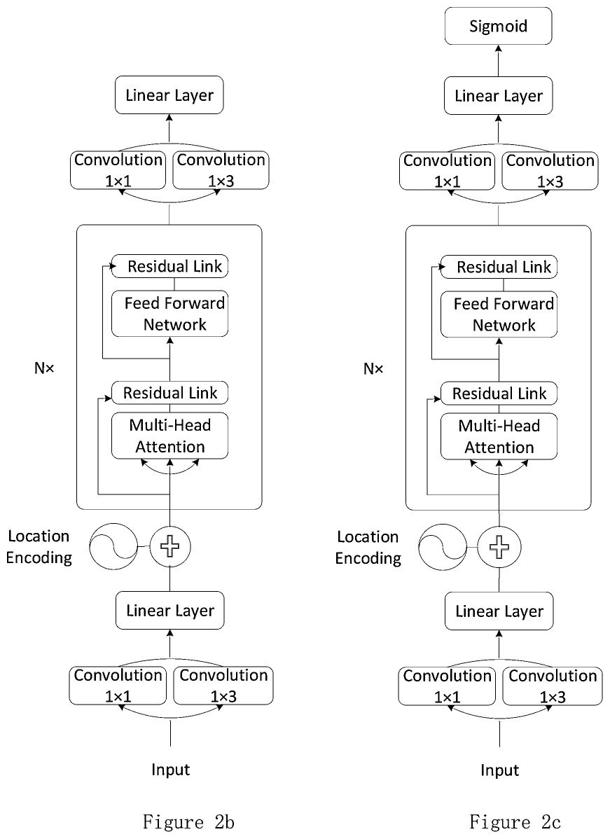

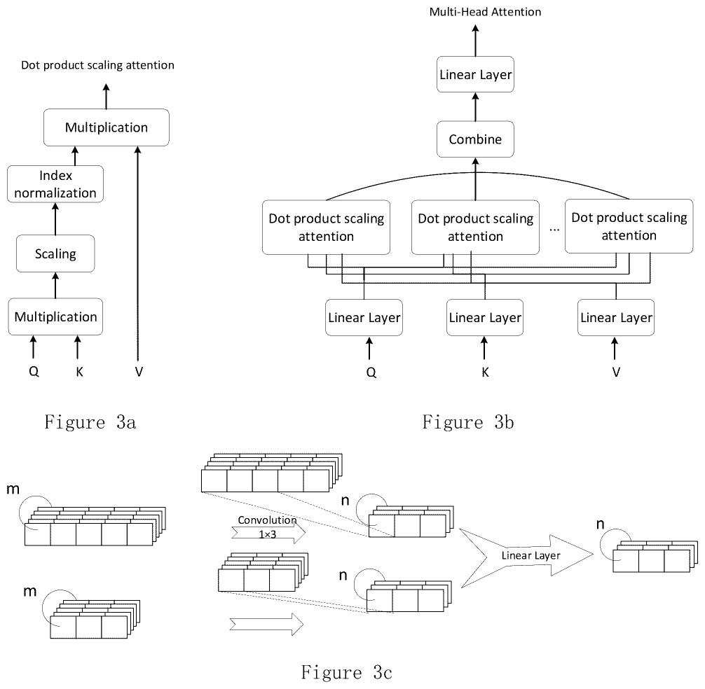

the training set data is used as the historical data set and the test set data is used as the missing data set; the attached FIG. 1 represents the technical process, including the following steps;

training phase, using historical data set data for training:

step 1: random missingness is performed on the dataset according to the specified missingness rates, here five sets of missingness rates {0.1, 0.3, 0.5, 0.7, 0.9} are taken, and the true values of these missing items are retained as subsequent judging information:

step 2: perform data pre-processing

1) uniformly standardize all sensor data using Equation (1) to obtain the standardized multivariate samples;

2) construct temporal samples using the sliding window method

using the sliding window method, the temporal information of the samples is extracted by sliding in the temporal dimension, where the feature dimension is 21, the window size is 30, and the step size is 5; a series of temporal samples with feature dimension X window size are constructed to generate the missing data matrix;

3) marking missing values

a mask matrix of equal size (21×30) to the missing data matrix is constructed, and the corresponding position in the mask matrix is marked as 1 for the unmissing items in the missing data matrix and 0 for the missing items to achieve the marking of the missing data and unmissing data;

step 3: pre-imputation

in the pre-imputation process, different algorithms can be used to pre-impute the data, and the good or bad pre-imputation also has some influence on the final imputation; here, the K-nearest neighbor algorithm is used to pre-impute the pre-processed data, in which the KNNImputer function in the Sklearn library is used in the K-nearest neighbor algorithm, and the value of K is taken as 14; the result of pre-imputation is the pre-imputation matrix, which is used as the subsequent input;

step 4: training the model using the training sample set

the training of the network includes two parts, the training of the generator G and the training of the discriminator D; as shown in equation (2), the generator consists of a parallel convolutional layer, a fully connected layer, a position encoding layer, a N-layer TransformerEncoder module, a parallel convolutional layer, and a fully connected layer; the discriminator D is based on the generator, and a sigmoid function is added to the last layer to convert the value domain to (0, 1) for the cross-entropy loss function; the discriminator D is based on the generator and adds a sigmoid function in the last layer to convert the value domain to (0, 1) for the calculation of the cross-entropy loss function;

firstly, the generator is trained, the missing data matrix X′, the random matrix Z, the mask matrix M and the pre-imputation matrix Xₚᵣₑ are used as the input of the generator G; the output generation matrix X_{g} is used to impute the missing values to obtain the imputed matrix Xᵢₘₚᵤₜₑ; the imputed matrix Xᵢₘₚᵤₜₑ, the hint matrix H generated from the mask matrix, and the pre-imputation matrix Xₚᵣₑ are input to the discriminator D to calculate and obtain X_{d}; loss_{g1} is calculated using equation: − [symbol] _{M,X}_{_{d}}((1−M)^{T}log(X_{d})); The reconstruction loss of the generated data and the non-missing data is calculated using equation: λ∥X′*M−X_{g}*M∥₂ to obtain loss_{g2}; the reconstruction loss of the generated data and the pre-imputed data is calculated using equation: β∥Xₚᵣₑ*(1−M)−X_{g}*(1−M)∥₂ to obtain loss_{g3}; combining loss_{g1}, loss_{g2}loss_{g3}:

$${G}_{loss} = {loss}_{g 1} + {loss}_{g 2} + {loss}_{g 3} \qquad ( 10 )$$

and it is fed back to the generator G and the gradient is updated by the Adam function;

then the training of discriminator D is carried out, where the imputed matrix Xᵢₘₚᵤₜₑ, the hint matrix H generated by the mask matrix and the pre-imputation matrix Xₚᵣₑ are input to discriminator D to calculate X_{d} and then equation (7) is used to calculate the cross-entropy loss function to obtain B, which is fed to discriminator D and gradient updated by the Adam function;

then the second iteration of training is carried out, i.e. the training process of generator G and discriminator D is repeated, and the generator G is trained iteratively so that the probability of the imputed sample [X_{g}*(1−M)] being identified as an unmissing sample (X′*M) by discriminator D is continuously increased, i.e. the sample distribution of the imputed sample and the sample distribution of the true sample, i.e. the sample of the unmissing item, are closer and closer; the parameters of the discriminator D are updated so that the discriminator D can accurately identify the imputed samples and the true samples; and so on, completing the model training several times, and finally, when the training number is reached, the training is withdrawn and the trained generator G and discriminator D are obtained;

in FD001 dataset training, window size is 30, step size is 5, batch size is 128, λ=10, β1/(Pmiss*10), Pmiss is the missing rate, dropout rate is 0.2, training count epoch is 15, the generator's learning rate is lrG=1.2e-3, the discriminator's learning rate is lrD=1.2e-1, the number of attention heads of the TransformerEncoder module was 8 and the number of stacking layers N was 2;

in the testing phase, the missing data set data is used for testing;

step 5: pre-processing and pre-imputation of the missing dataset data

the missing data set is pre-processed and pre-imputed as shown in step 2 and step 3; here the window size=step=30, the missing data matrix, the random matrix Z, the mask matrix M and the pre-imputed matrix Xₚᵣₑ are generated;

step 6: missing data set imputation

the matrix generated in step 5 is fed into the generator G trained in step 4 to obtain the output X_{g} of the generator and then using equation (9), the final imputed matrix Xᵢₘₚᵤₜₑ is obtained;

### Implementation Results

in this paper, for the C-MAPSS dataset commonly used for aero-engine health management, the C-MAPSS experimental data is a dataset without missing values, for which the FD001 dataset, this paper constructs a missing dataset containing missing values by simulating missing engine sensor data through manual random missing at five sets of missing rates {0.1, 0.3, 0.5, 0.7, 0.9}; the missing sample set is then combined with test_FD001 and train_FD001 divided in the original dataset, and then randomly disrupted by engine number as the smallest unit, 80% of the data with engine number is selected as the training set and 20% of the data with engine number is used as the test set for the validation of the algorithm;

the RMSE is defined as follows, where yᵢ is the true value and ŷᵢ is the reconstructed value, and the smaller the RMSE, the smaller the difference between the reconstructed value and the true value, and the better the complementary performance:

$$RMSE = \sqrt{\frac{1}{2} {\sum }_{i = 1}^{n} {( {y}_{i} - {\hat{y}}_{i} )}^{2}} \qquad ( 11 )$$

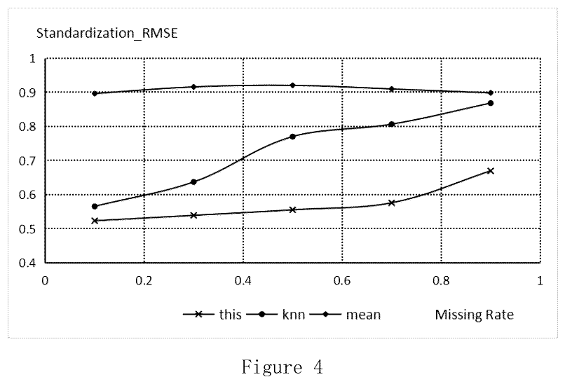

in addition, since the above data set division has a random nature, i.e. the length of the data sequence under each engine number is different and the engine numbers are randomly scrambled, the results of each training and testing will be random, so each algorithm was trained and tested five times under each missing rate and the average was taken as the final result, Table 1 shows the final result and FIG. 4 shows the result graph;

TABLE 1
imputation accuracy RMSE for FD001 dataset at different deletion rates

| | Missing rate | | | | |
|---|---|---|---|---|---|
| Algorithms | 0.1 | 0.3 | 0.5 | 0.7 | 0.9 |
| this | 0.5230_{-0.006}^{+0.005} | 0.5388_{-0.0058}^{+0.0032} | 0.5552_{-0.0102}^{+0.0078} | 0.5756_{-0.0196}^{+0.0094} | 0.6692_{-0.0222}^{+0.0228} |
| knn | 0.5652_{-0.0062}^{+0.0098} | 0.6368_{-0.0108}^{+0.0102} | 0.7698_{-0.0148}^{+0.0092} | 0.8062_{-0.0112}^{+0.0128} | 0.8680_{-0.008}^{+0.007} |
| mean | 0.8960_{-0.016}^{+0.007} | 0.9156_{-0.0126}^{+0.0114} | 0.9202_{-0.0152}^{+0.0138} | 0.9094_{-0.0134}^{+0.0166} | 0.8982_{-0.0222}^{+0.0208} |

as can be seen from Table 1, under the C-MAPSS dataset commonly used for aero-engine health management, the present invention not only has better completeness at the same missing rate compared to the benchmark algorithm, but also has better stability as the missing rate increases; once the missing data has been reconstructed, it can be used as a dataset for subsequent fault diagnosis and health maintenance work, providing greater accuracy while maximising the use of aero-engine sensor data containing missing data;

although embodiments of the present invention have been shown and described above, it is understood that the above embodiments are only for the purpose of illustrating the technical solution of the present invention and are not to be construed as limiting the invention, and that those of ordinary skill in the art may make modifications and substitutions within the scope of the present invention without departing from the principles and purposes of the present invention;

1. A generative adversarial multi-head attention neural network self-learning method for aero-engine data reconstruction, comprising the following steps:
step S1: preprocessing a sample
1) dividing an aero-engine data set with a missing value into a training sample set and a test sample set, wherein the training sample set is used for training a model, and the test sample set is used for checking the model after training; assuming that the aero-engine data set has n attributes, then the aero-engine data set is uniformly represented by X={X₁, X₂, . . . Xₙ};
2) marking the missing value
since X contains the missing value, a missing item is represented by NAN, and an unmissing item is an original value, constructing a mask matrix M equal to X in size, marking a corresponding position of the mask matrix as 0 for the missing item in X, and marking a corresponding position of the mask matrix as 1 for the unmissing item in X, thus to mark missing data and unmissing data;
3) making different features have the same scale through standardization; for the unmissing item, using the following formula to standardize all sensor data,
$${X}_{i}^{′} = \frac{{X}_{i} - {mean}_{i}}{{σ}_{i}} i ∈ ( 1 , 2 , … n ) \qquad ( 1 )$$
wherein X′ᵢ represents standardized data of a feature i, Xᵢ represents original data of the feature i, meanᵢ represents a mean value of the feature i, and σᵢ represents a variance of the feature i; for the missing item, replacing NAN with 0 to finally obtain standardized multivariate time series data X′={X′₁, X′₂, . . . X′ₙ};
4) constructing time series samples by a sliding window method
for X′ and M, sliding in a time dimension by a sliding window method to extract time information of the sample and construct a series of time series samples of n×Windowsize, wherein n is a feature dimension of the samples, and Windowsize is a window size, i.e., reconstructing X′ and M into the form of m×n×Windowsize, wherein m is a sample size which depends on an original sample size;
step S2: conducting pre-imputation
in order to make the data generated by a network better fit original data distribution, adopting a machine learning algorithm to pre-impute X′, and using the pre-imputed information as partial training information Xₚᵣₑ to participate in network training;
step S3: constructing a generative adversarial multi-head attention network model
1) a generative adversarial network modeling method based on a convolutional multi-head attention mechanism for aero-engine missing data is mainly composed of a generator G and a discriminator D; the generator G is composed of a parallel convolutional layer, a fully connected layer, a position encoding layer, an N-layer TransformerEncoder module, another parallel convolutional layer and another fully connected layer, and is represented by the following formula:
$$Conv 1 {d}_{1 \times 1} \& Conv 1 {d}_{1 \times 3} - Linear - PositionalEncoding - N \times TransformerEncoder - Conv 1 {d}_{1 \times 1} * Conv 1 {d}_{1 \times 3} - Linear \qquad ( 2 )$$
2) constructing a random matrix Z equal to X in size, filling in a random number with a mean value of 0 and a variance of 0.1 for missing item data, and filling in 0 for unmissing item data; introducing a random value to make subsequent model training more robust;
constructing a matrix M′ which is identical to M according to the mask matrix M, and then setting all 0 terms in M′ to 1 with a probability of 90% to finally obtain a hint matrix H;
as input data of the generator G includes the standardized multivariate time series data X′, the random matrix Z, the mask matrix M and a pre-imputation matrix Xₚᵣₑ, using the parallel convolutional layers to extract correlation information between the attributes, using position codes to encode time series information of the input data, using the N-layer TransformerEncoder module to effectively extract the time series information, using the parallel convolutional layers and the fully connected layers to output complete data information X_{g}, and using X_{g} to impute the missing item in X′; the discriminator D is similar to the generator G in structure, a Sigmoid activation function is only added in the last layer to calculate a cross entropy loss, input of the discriminator includes an imputed data matrix Xᵢₘₚᵤₜₑ as well as the hint matrix H and the pre-imputation matrix Xₚᵣₑ generated by the mask matrix, output of the discriminator is a prediction matrix X_{d}, and an element value in the prediction matrix represents the probability that a corresponding element in Xᵢₘₚᵤₜₑ is real data;
step S4: training the generative adversarial multi-head attention network model by the training sample set
$$\begin{matrix}{D}_{loss} = - {𝔼}_{M , {X}_{d}} ( {M}^{T} log {X}_{d} + {( 1 - M )}^{T} log ( 1 - {X}_{d} ) ) & ( 7 ) \\ {G}_{loss} = - {𝔼}_{M , {X}_{d}} ( {( 1 - M )}^{T} log ( {X}_{d} ) ) + λ {‖ {X}^{′} * M - {X}_{g} - M ‖}_{2} + β {‖ {X}_{pre} * ( 1 - M ) - {X}_{g} * ( 1 - M ) ‖}_{2} & ( 8 )\end{matrix}$$
1) the training of the network comprises two parts: training of the discriminator D and training of the generator G, wherein formula (7) is a cross entropy loss function of the discriminator D, and formula (8) is a loss function of the generator G; in the formulas, [symbol] represents expectation, M is the mask matrix, Xₚᵣₑ is pre-imputed data, X_{g} is the data generated by the generator G, X_{d} is probability matrix output by the discriminator D, and λ and β are hyperparameters; the following formula (9) is an imputed data set;
$${X}_{impute} = {X}^{′} * M + {X}_{g} * ( 1 - M ) \qquad ( 9 )$$
2) the generator G and the discriminator D are trained alternately, the generator is used for generating a sample X_{g} to simulate the distribution of the real data (i.e., the unmissing item data) as far as possible, the discriminator D is used for discriminating the probability that the sample generated by the generator G is true, and the generator G and the discriminator D compete with each other and promote each other;
step S5: generating the sample by the trained sample generator G
after training, preprocessing the test sample set as shown in step 1, and inputting the trained generator G to obtain the generated sample X_{g};
step S6: reconstructing the missing value by the generated sample
obtaining a complete imputed sample Xᵢₘₚᵤₜₑ by formula (9) to complete missing data reconstruction of the whole data set; after the missing data reconstruction, the data set can be used as a data set for subsequent fault diagnosis and health maintenance, thus to maximize the utilization rate of aero-engine sensor data containing missing data.

2. The generative adversarial multi-head attention neural network self-learning method for aero-engine data reconstruction according to claim 1, wherein in step S3:
the parallel convolutional layers and the fully connected layers are used for extracting the attribute correlation of aero-engine multivariate data, the parallel convolutional layers are composed of Conv1d_{1×1} and Conv1d_{1×3} connected in parallel, and are then combined through the fully connected layers to be used as subsequent input of the position encoding layer;
the position encoding layer is used for enabling the model to use the order of a sequence to inject information about a relative or absolute position marked in the sequence; therefore, adding PositionalEncoding to the input, and conducting position encoding by formula (3), wherein n is a window size, pos is the position information of time, d_{model} is a total dimension of data, d is the number of dimensions, d∈(0,1 . . . d_{model}−1), and
$$i = ⌊ \frac{d}{2} ⌋ ;$$
that is to say, each dimension of position encoding corresponds to a different sine/cosine curve, according to which the position of the input data can be individually and uniquely marked and finally used as subsequent input of the N-layer TransformerEncoder module;
$${PE}_{( pos , 2 i )} = sin ( pos / {10000}^{2 i / {d}_{model}} ) \\ {PE}_{( pos , 2 i )} = cos ( pos / {10000}^{2 i / {d}_{model}} ) \\ pos ∈ ( 1 , 2 … n ) , i ∈ ( 0 , 1 … \frac{{d}_{model}}{2} - 1 ) \qquad ( 3 )$$
the N-layer TransformerEncoder module is a module formed by N TransformerEncoders connected in series, and each TransformerEncoder is composed of a multi-head attention module layer, a residual connection layer, a feed forward network layer and another residual connection layer, and is represented by the following formula:
MultiHead Attention−Add & Norm−Feed Forward−Add & Norm (4) wherein MultiHead Attention is formed by a plurality of Attention modules spliced in parallel, each Attention module is represented by formula (5), and a MultiHead Attention module is represented by formula (6),
$$\begin{matrix}Attention ( Q , K , V ) = softmax ( \frac{{QK}^{T}}{\sqrt{{d}_{k}}} ) V & ( 6 ) \\ MultiHead ( Q , K , V ) = Concat ( {head}_{1} , … , {head}_{h} ) {W}^{O} \\ {head}_{i} = Attention ( {QW}_{i}^{Q} , {KW}_{i}^{K} , {VW}_{i}^{V} ) i ∈ ( 1 , 2 … h ) & ( 6 )\end{matrix}$$
wherein h represents the number of heads of multi-head attention, and Wᵢ^{Q}∈ [symbol] ^{d}^{_{model}}^{×d}^{ₖ}, wᵢ^{K}∈ [symbol] ^{d}^{_{model}}^{×d}^{ₖ}, Wᵢ∈ [symbol] ^{d}^{_{model}}^{×d}^{ᵥ} and W^{O}∈ [symbol] ^{hd}^{ᵥ}^{×d}^{_{model}} represent corresponding unknown weights respectively; Attention can be described as mapping a query Q and a key-value pair K-V to the output, wherein Q, K, V and the output are all vectors, and the value of the output is the weighted sum of calculated values; when inputs of Q, K and V are the same, the Attention is called self attention.
